(19) United States
(12) Patent Application Publication
(10) Pub. No.: US 2013/0104444 A1
(43) Pub. Date: May 2, 2013

(54) Fly Rod and Reel System

(71) Applicant: Darrell Sutherland, Buckley, WA (US)

(72) Inventor: Darrell Sutherland, Buckley, WA (US)

(21) Appl. No.: 13/283,234

(22) Filed: Oct. 27, 2011

(51) Int. Cl. A01K 87/06; A01K 87/08

(52) U.S. Cl. 43/20; 43/23

(57) ABSTRACT

A fly fishing rod and reel system in which the reel is positioned rearward from the proximal end of the rod so that load bearing point is repositioned to the reel and the user's forearm and not the user's wrist when casting and fish fighting. In three embodiments, the reel is attached to a positioning member that positions the reel so that its transverse axis is longitudinally aligned with the rod's longitudinal axis and the reel extends beyond the proximal end of the rod thereby creating a new fulcrum point under the user's forearm when casting and fish fighting. By positioning the reel rearward, the user's wrist can lock when casting and press the reel against the forearm to ensure proper casting technique is used. The fly line is within reach of the user's fingers and the reel may be pressed against the abdomen to create drag on the reel.

### COPYRIGHT NOTICE

Notice is hereby given that the following patent document contains original material which is subject to copyright protection. The copyright owner has no objection to the facsimile or digital download reproduction of all or part of the patent document, but otherwise reserves all copyrights whatsoever.

### BACKGROUND OF THE INVENTION

1. Field of the Invention

The present invention pertains to fly rods and reels, and more particularly to fishing rods and reels designed to improve casting and reduce wrist and forearm fatigue.

2. Description of the Related Art

Fly fishing requires the user to perfect the task of casting a specialized weighted fly line and a weightless fly. The task of casting requires that the tip of the fly rod and the fly be whisked back and forth over the shoulder until the tip of the fly rod is loaded with sufficient energy to project the fly line forward a desired distance. The fly line then falls gently into the water simulating the movement of a natural insect. Unfortunately, casting is an acquired skill that is mastered with practice.

When fishing, the fisherman holds the grip handle on the rod in one hand and rewinds the spool with the opposite hand. The palm and wrist on the hand holding the rod acts as a load bearing point and as a fulcrum point respectively. When fishing, specifically casting or fish fighting, the wrist can become fatigued.

Also when fishing, it is desirable to apply tension or drag to the reel to prevent the spool from unwinding when fish fighting. On some reels, an adjustable drag feature is provided on the reel that allows the user to manually adjust the amount of drag applied to the reel. Unfortunately, some fisherman find the adjustable drag feature on some reels to be burdensome.

### SUMMARY OF THE INVENTION

At the heart of the invention is the discovery that repositioning the reel so that the reel's transverse axis is longitudinally aligned with the rod's longitudinal axis and extending the reel from the rod's proximal end forces repositions the fulcrum point when holding the handle of the fly rod with a rigid wrist and casting, the wrist undergoes less fatigue. Also, because the reel is located rearward from the proximal end of the fly rod, the reel may be continuously pressed against the forearm when casting thereby providing the user with tactile feedback information.

The present invention is a fly fishing rod and reel system that includes a fly rod, a reel and a reel positioning member used for holding the reel rearward from the fly rod's proximal end and with the reel's transverse axis aligned with the rod's longitudinal axis. In the invention described herein, three embodiments of the reel positioning member are disclosed. In two embodiments, the reel positioning member is an straight intermediate member that extends between the fly rod's proximal end and the reel's outer housing. In another embodiment, a reel positioning member is a bracket that attaches to the segment of the rod adjacent to the grip handle and extends downward, rearward and upward to hold the reel rearward to the rod's proximal end and aligned with the longitudinal axis. In all embodiments, the reel is aligned and extended from the proximal end of the rod, so that when the user's wrist becomes locked or fixed when casting, the fulcrum or load bearing point on the rod is moved rearward and repositioned to the reel and the user's forearm.

Because the outer perimeter of the reel is exposed, the user may also comfortably rest the reel against the under surface of the forearm. In some instance, a portion of the spool may also be exposed which may be pressed against the user's abdomen to create drag. Also, because the spool is moved rearward relative to the proximal end of the rod, the angle of the fly line from the spool is reduced thereby positioning the fly line closer to the user's fingers and within easy reach to apply finger drag or strippling control when desired.

The reel may also include an optional, adjustable protective guard that: (1) acts as an arm or hand rest that prevents the arm or hand when resting against the reel's outer housing from contacting the spool and preventing its free rotation; and, (2) acts as a ground support that prevents dirt and rocks from contacting the spool and the outer housing when the reel is placed on the ground.

### DESCRIPTION OF THE DRAWINGS

FIG. 1 is a side elevational view of a user holding the first embodiment of the fly rod and reel system with the reel position under the forearm.

FIG. 2 is a side elevational view of the user whisking the fly rod and reel system with the wrist and elbow shown in fixed angles.

FIG. 3 is a side elevational view of a user holding the fly rod and reel system shown in FIGS. 1 and 2 with the reel positioned against the user's abdomen to create drag resistance.

FIG. 4 is an exploded, perspective, right side view of the first embodiment of the fly rod and reel system.

FIG. 5 is an exploded, perspective, left side view of the first embodiment of the fly rod and reel system.

FIG. 6 is a side elevation view of the second embodiment of the fly rod and reel system.

FIG. 7 is a top plan view of the second embodiment shown in FIG. 6.

FIG. 8 is an exploded side elevational view of the second embodiment shown in FIGS. 6 and 7.

FIG. 9 is a side elevational view of the fly rod and reel system that uses a post-style intermediate member.

FIG. 10 is an exploded, perspective view of the post-style intermediate member.

FIG. 11 is a side elevational view of an optional, adjustable protective guard attached around the fly rod and reel system shown in FIGS. 9 and 10.

FIG. 12 is a top plan view of the fly rod and reel system with the protective guard shown in FIG. 11.

FIG. 13 is a rear perspective view of the fly rod and reel system with the protective guard shown in FIGS. 11 and 12.

FIGS. 14 and 15 are front and rear elevational views, respectively, of the fly rod and reel system with the protective guard showing the rotating bracket being rotated into different positions over the reel.

FIG. 16 is a perspective view of a second embodiment of the protective guard.

### DESCRIPTION OF THE PREFERRED EMBODIMENT(S)

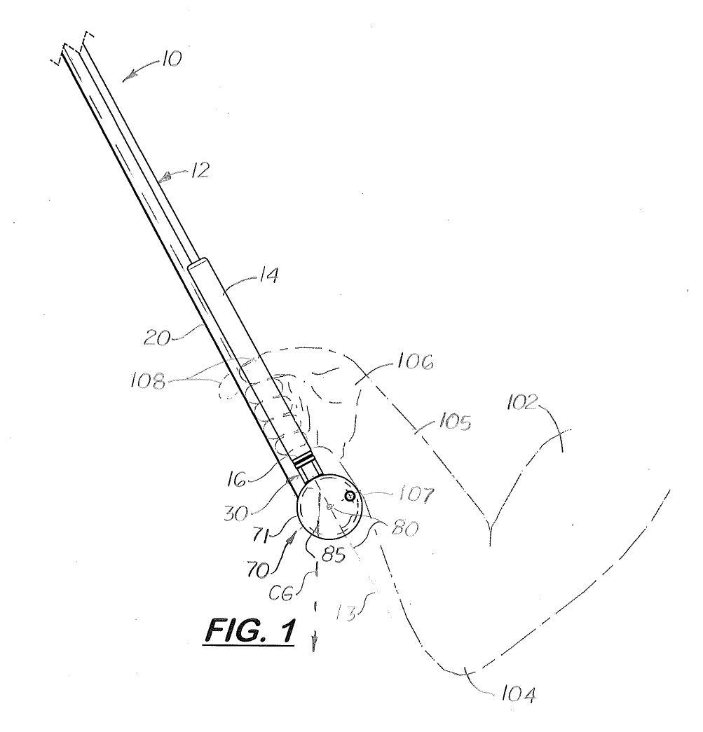

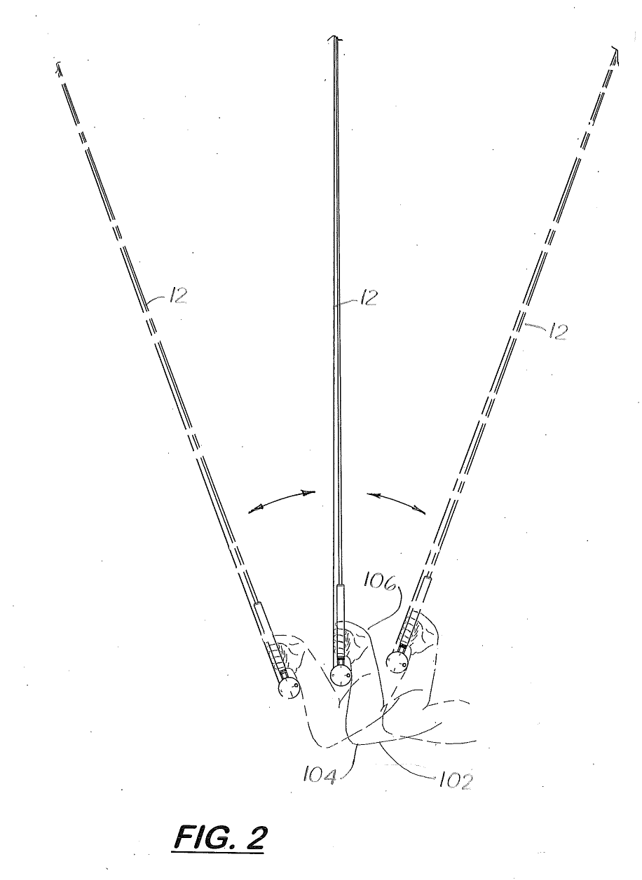

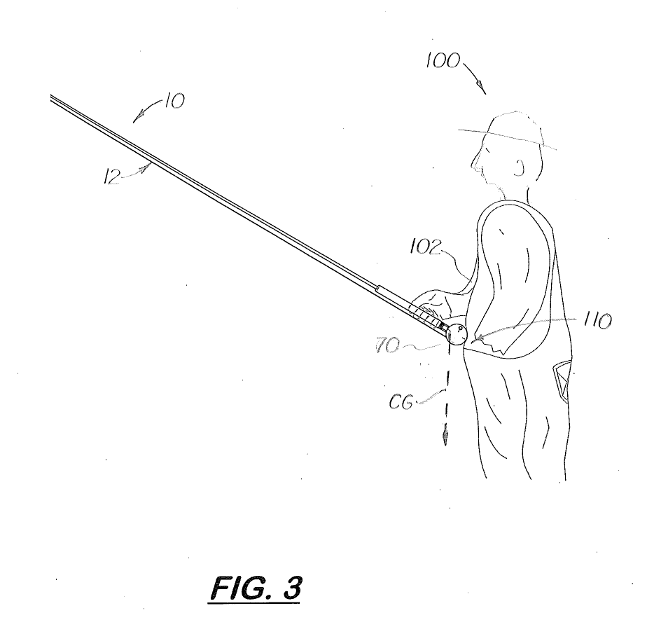

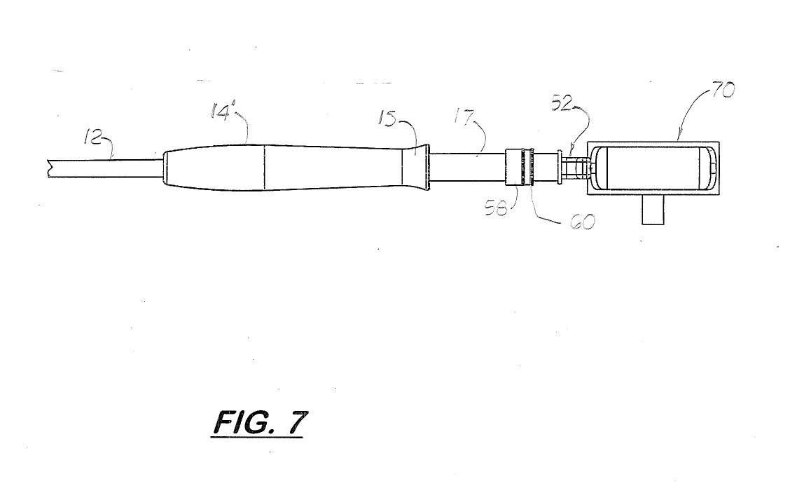

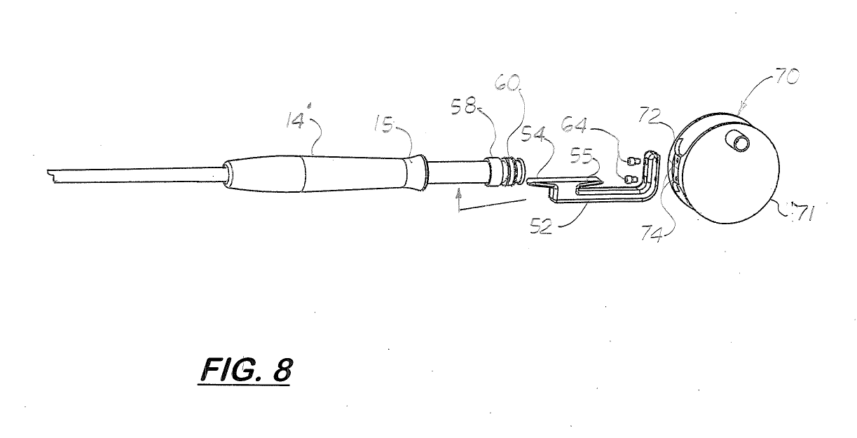

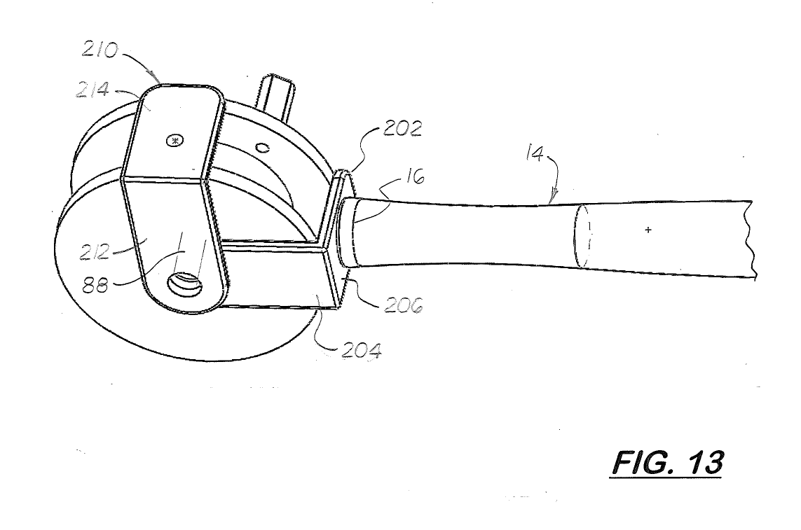

Referring to the accompanying FIGS. 1-16, there is shown a fly fishing rod and reel system 10 in which the reel 70 is positioned rearward to the proximal end 16 of the fly rod 12 so that the rod's longitudinally axis 13 passes through or near the reel's transverse axis 80. By moving the reel 70 to an extended position and rearward from the rod's proximal end 16, the load bearing point 107 moved from the user's wrist to a contact point where the reel 70 presses against the user's forearm 105. (see FIG. 1). When casting, the user 100 whisks the rod 12 back and forth using the entire arm 102 (see FIG. 2) to impart sufficient energy into the tip of the rod to project the fly line in a forward direction. Also when fish fighting, the user 100 may hold the grip handle 14 on the rod 12 so that the reel 70 is pressed against the user's abdomen 110 to support the end of the rod 12 and in some instances, impart resistance to the reel 70 (see FIG. 3).

In a first embodiment of the invention shown in FIGS. 1-3, the system 10 includes a fly rod 12 with a grip handle 14. Attached to the proximal end 16 of the grip handle 14 is a reel positioning member 30 designed to connect to and hold a reel 70 that includes an inner rotating spool 85 housed inside an outer housing 71. The reel positioning member 30 holds the reel 70 rearward from the rod's proximal end 16 so that its fore to aft transverse axis 80 is aligned with the rod's longitudinally axis 13.

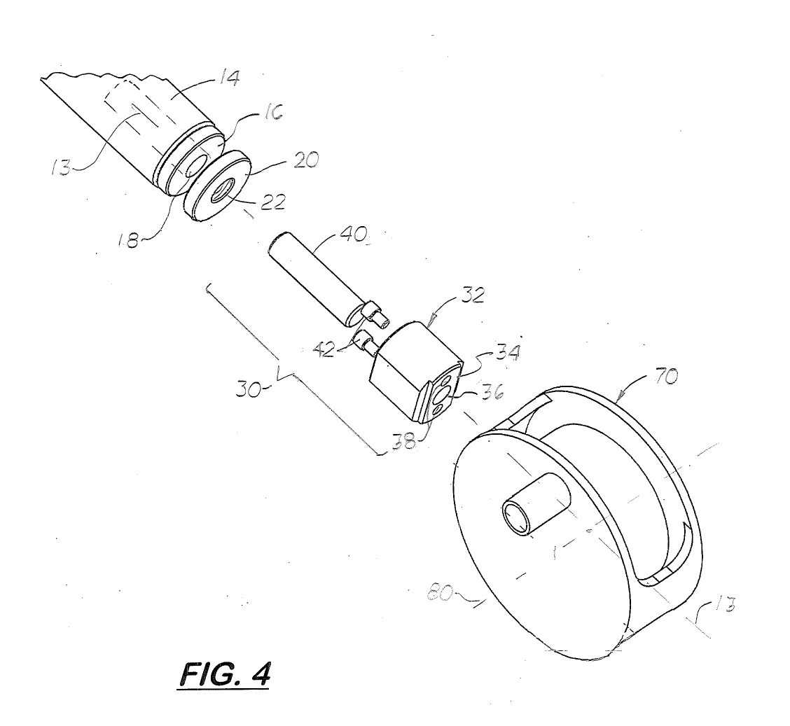

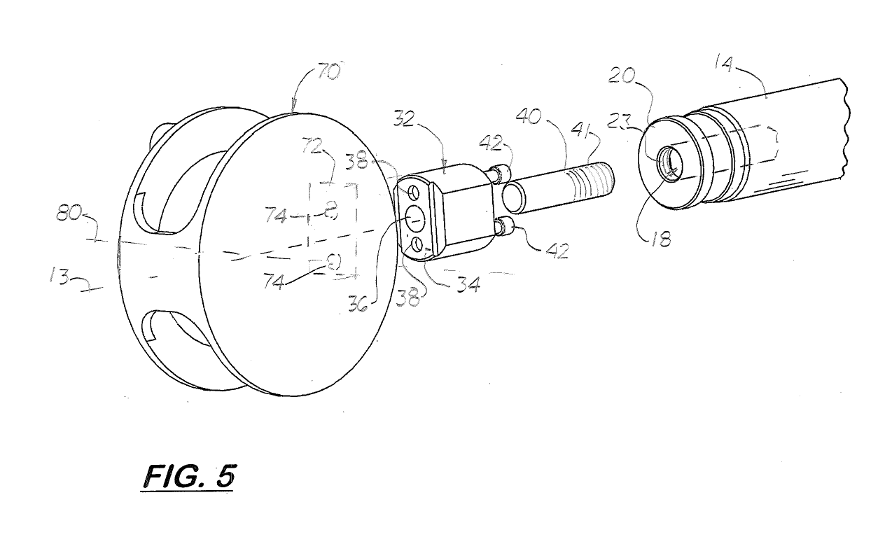

In the first embodiment shown in FIGS. 4 and 5, the reel position member 30 includes a short support rod 40 designed to partially fit into the elongated bore 13 formed on the proximal end 16 of the handle 16. Disposed on the proximal end 16 and around the support rod 40 is a threaded nut 20 with a threaded center hole 23 that engages external threads 42 on the support rod 40. Support rod 40 partially extends into the bore 13. The opposite, exposed end of the support rod 40 extends rearward from the rod's proximal end 16 and attaches to a connection block 32. The connection block 32 includes a rear flat mounting surface 34 and a center bore 36. Located on opposite sides of the center bore 36 are two bores 38 through which two threaded connectors 42 extend and connect to two threaded bores 74 located on the mounting surface 72 of the reel 70.

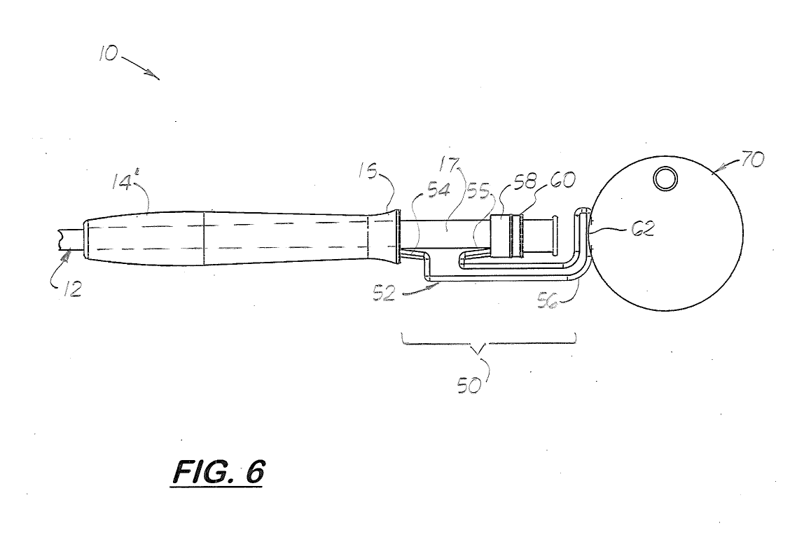

In a second embodiment of the invention shown in FIGS. 6-8, the fly fishing rod and reel system 10 includes a fly rod 12 with a reel positioning member 30 that includes a reel bracket 52 designed to attached to the fly rod's grip handle 14′. The grip handle 14′ includes a flare seating collar 15 with a rear portion 17 that extends rearward therefrom. Attached to the rear portion 17 is a rotating nut 58 and a fixed anchor collar 60. Located under the rear portion 17 is the reel bracket 52 that includes an upper straight, rod alignment section 53 designed to rest against the lower surface of the grip handle's rear portion 17. The alignment section 53 includes a beveled forward ear 54 and a beveled rearward ear 55. During assembly, the beveled forward ear 54 slides under the flare seating collar 15 while the beveled rearward ear 55 slides under the rotating nut 58. When properly positioned, the rotating nut 58 is tightened on the fixed anchor collar 60 to securely hold the reel bracket 52 in place under the rod 12.

The reel bracket 52 also includes an integrally formed, upward extending rear support arm 58 with bores 59 formed therein that received two threaded connectors 64. The support arm 58 has sufficient width and length that allow it to fit completely against a mounting surface 72 formed on the outer housing 71. Two threaded connectors 64 extend through the two bores 59 and extend into the two threaded bores 74 formed on the mounting surface 72 to securely connect the rear support arm 58 to the outer housing 71.

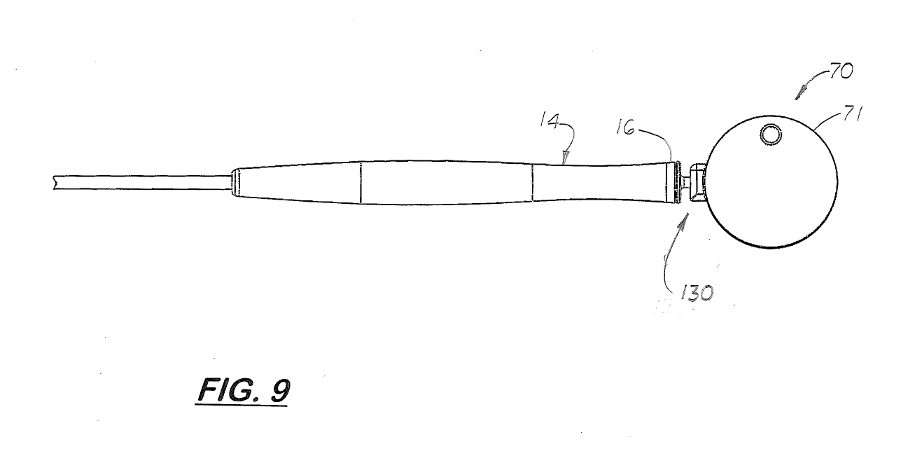

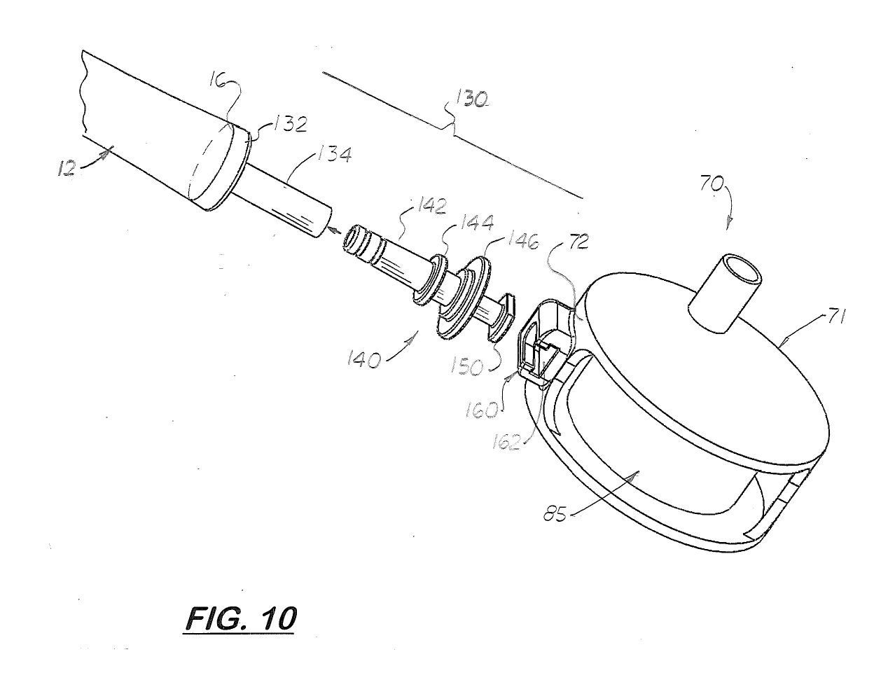

In a third embodiment of the system 10, shown in FIGS. 9 and 10, the reel positioning member 30 comprises a t-shaped post adapter 130 with an end cap 132 that is adhesively or integrally molding into the proximal end 16 of the rod 12. Attached to and extending perpendicularly from the end cap 132 is a hollow post 134. Attached to the post 34 is a post coupler 140 that includes a center peg 142 that slides longitudinally into the post 134. Attached to the center peg 142 is a small washer 144 and a larger stop flange 146. The end of the center peg 142 extends beyond the stop flange 146 and connects to a perpendicularly aligned, rectangular slide plate 150.

During use, the slide plate 150 is selectively attached to a slide receiver 160 formed or attached to the reel's outer housing 71. The slide receiver 160 includes a slot 162 keyed and complimentary in shape to the slide plate 150 that receives the slide plate 150 to selectively attach the reel 70 to the rod 12.

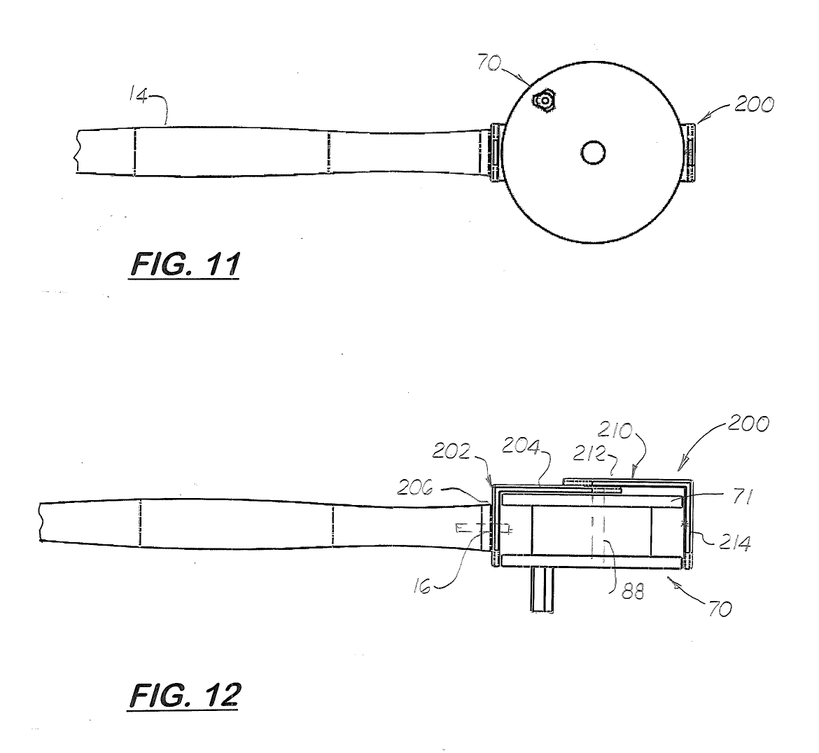

As shown in FIGS. 11-15, each reel 70 may also include an optional, adjustable protective guard 200 that: (1) acts as an arm or hand rest that prevents the arm or hand when resting against the reel's outer housing 71 and interfering with the rotation of the spool 85; and, (2) acts as a ground support that prevents dirt from contacting the spool 85 and the outer housing 71 when the reel 70 is placed on the ground. The protective guard 200 includes a stationary bracket 202 fixed to the proximal end 16 of the rod and a rotating bracket 210. In the embodiment shown in FIGS. 11-15, the stationary bracket 202 includes a long, longitudinally aligned leg 204 that extends rearward and longitudinally from the proximal end of the rod and a short transverse leg 206 that is positioned adjacent to the proximal end 16 of the rod 12. The rotating bracket 210 includes a long, leg 212 that extends rearward and short transverse leg 214 that extends across the outside edge of the outer housing 71. The opposite ends of the two longitudinal legs 204, 212 on legs 202, 210, respectively, are connected to the reel's axle 88.

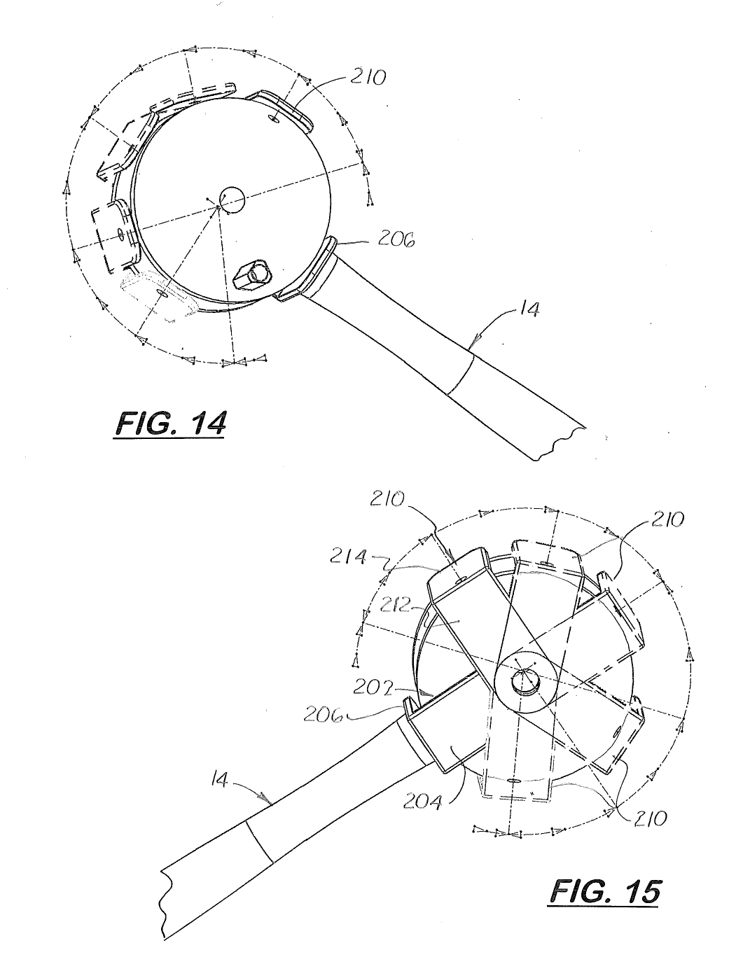

FIGS. 14 and 15 are front and rear elevational views, respectively, of the rod and reel system 10 with the rotating bracket 210 being re-aligned into different positions over the reel 70.

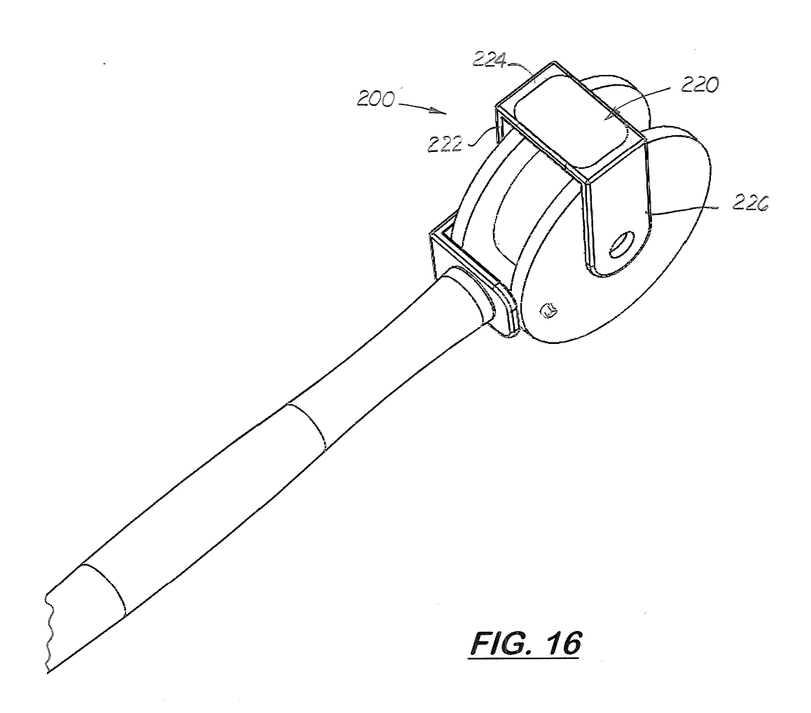

FIG. 16 is a perspective view of a second embodiment of the protective guard 200 in which the L-shaped rotating bracket 202 is replaced by a U-shaped rotating bracket 220 that includes two radially aligned arms 222, 226 attached at one end to the reel's center axle (not shown), and an interconnecting intermediate arm 224 upon which the user's arm or hand may be placed.

As stated above, in every embodiments of the system 10 presented herein, the reel 70 is longitudinally and extended rearward from the proximal end 16 of the rod 12. During use, the user holds the handle or butt portion of the rod 12 with one hand so that the reel 70 is positioned under the user's forearm 105. When the reel 70 is pressed against the forearm, a new fulcrum point is created under the forearm 105 (rather than the wrist). When casting, the user holds the rod 12 so that the reel 70 is in constant contact with the forearm 105. The user then locks the wrist 106 and the elbow 104 and whisks the rod 12 back and forth using primarily his or her shoulder.

It should be also noted that by longitudinally aligned the reel 70 with the rod's longitudinal axis 13 and by positioning the reel 70 rearward from the proximal end 16, the rod's center of gravity is repositioned rearward and in alignment with the rod's longitudinal axis which changes the dynamics of casting and fish fighting. Also, by moving the rod's center of gravity in this manner, gravity is able to assist the user when casting by automatically forcing the rod's tip up with the reel 70 acting as a catapult weight to assist in the forward and back motion of casting. Further, by repositioning the reel 70 rearward on the rod 12, the reel 70 acts as a pendulum counterbalance for whisking the rod back and forth much like a pendulum in a clock or a metronome music timer.

Another benefit of the system 10 is that no other structure covers or extends from the reel 70 or rod 12 so that the reel 70 may rest comfortably against the under surface of the forearm 105 or against the abdomen 110 to create drag on the reel 70.

A further benefit is that due to the reel's location relative on the rod 12, the section of exposed fly line 20 adjacent to the rod 12 is closer to the user's fingers 108 than a standard fly rod and reel thereby enabling the user to reach the fly line 20 when necessary (see FIG. 1).

In compliance with the statute, the invention described herein has been described in language more or less specific as to structural features. It should be understood however, that the invention is not limited to the specific features shown, since the means and construction shown, is comprised only of the preferred embodiments for putting the invention into effect. The invention is therefore claimed in any of its forms or modifications within the legitimate and valid scope of the amended claims, appropriately interpreted in accordance with the doctrine of equivalents.

I claim:

1. A fly fishing rod and reel system, comprising;
a. a fly rod with a proximal end, a distal end, a longitudinal axis and a grip handle located near said proximal end;
b. a reel that includes an outer housing with a transverse axis that is aligned with said longitudinal axis of said fly rod, said reel also includes a rotating, coaxially aligned spool located inside said outer housing with a fly line wound thereon; and,
c. a reel positioning member for connecting said reel to said fly rod and holding said reel rearward from said proximal end of said rod and said reel's transverse axis aligned with said longitudinal axis on said fly rod.

2. The fly rod and reel system as recited in claim 1, wherein said reel positioning member for connecting said reel to said fly rod includes a support rod, a bore formed on said proximal end of said fly rod, and a connection block, said support rod being longitudinally aligned with said fly rod and partially extended into said bore, said connection block being attached to an exposed end of said support rod and connected to a mounting surface on said outer housing of said reel.

3. The fly rod and reel system as recited in claim 1, wherein said reel positioning member for connecting said reel to said fly rod includes,
a reel bracket attached to said grip handle on said fly rod that includes a rear portion on said fly rod with a flare seating collar attached thereto, also attached to said rear portion is a rotating nut 58 and a fixed anchor collar 60, formed under said rear portion is the reel bracket that includes an upper straight, rod alignment section that rests against said rear portion on said fly rod, said alignment section includes a forward ear and a rearward ear, wherein during assembly said forward ear slides under said flare seating collar and said rearward ear slides under said rotating nut and when said rotating nut is tightened against said fixed anchor collar, said reel bracket is securely held in place on said rod; and
an integrally formed, upward extending rear support arm formed on said bracket, said support arm 58 being sufficient in width and length to hold a reel attached thereto so that said reel's transverse axis is longitudinally aligned with said longitudinal axis on said rod.

4. The fly rod and reel system as recited in claim 1, wherein said means for connecting said reel to said fly rod includes a t-shaped post adapter with a slide plate attached to said proximal end that selectively engages a complimentary shaped slide receiver attached to said outer housing of said reel.

5. The fly rod and reel system as recited in claim 1, further including a protective guard mounted on said reel that includes stationary bracket fixed to the proximal end of the rod and said reel and a rotating bracket that rotates around said spool.

6. The fly rod and reel system as recited in claim 2, further including a protective guard mounted on said reel that includes stationary bracket fixed to the proximal end of the rod and said reel and a rotating bracket that rotates around said spool.
rod and reel system as recited in claim 1, further including an protective guard mounted on said reel that includes stationary bracket fixed to the proximal end of the rod and said reel and a rotating bracket that rotates around said spool.

7. The fly rod and reel system as recited in claim 3, further including a protective guard mounted on said reel that includes stationary bracket fixed to the proximal end of the rod and said reel and a rotating bracket that rotates around said spool.

8. The fly rod and reel system as recited in claim 4, further including a protective guard mounted on said reel that includes stationary bracket fixed to the proximal end of the rod and said reel and a rotating bracket that rotates around said spool.

9. A wrist fatigue-reducing fly fishing rod and reel system, comprising;
a. a fly rod with a proximal end, a longitudinal axis and a grip handle;
b. a reel with an outer housing with a transverse axis and a rotating, coaxially aligned spool located inside said housing, said spool includes a fly line wound thereon; and,
c. means for holding said reel rearward from said proximal end of said rod and with said transverse axis on said reel aligned with said longitudinal axis on said rod, said means for holding said reel holds said reel so that it may be held with one hand on said grip handle, said reel extends under a user's forearm and acts as a fulcrum and force loading point when casting for fish fighting thereby reducing wrist fatigue.

10. A fly fishing rod and reel system, comprising;
a. a fly rod with a proximal end, a distal end, a longitudinal axis and a grip handle located near said proximal end;
b. a reel with a rotating, coaxially aligned spool fly line wound thereon, said real including a transverse axis and being attached to said rod so that said reel is located behind said proximal end and said transverse axis is longitudinally aligned with said longitudinal axis on said rod.
